(19) United States
(12) Patent Application Publication
(10) Pub. No.: US 2011/0200839 A1
(43) Pub. Date: Aug. 18, 2011

(54) Rare Earth Laminated, Composite Magnets With Increased Electrical Resistivity

(76) Inventors: Melania Marinescu, Reinholds, PA (US); Jinfang Liu, Lancaster, PA (US)

(21) Appl. No.: 12/707,227

(22) Filed: Feb. 17, 2010

(51) Int. Cl. H01F 1/08

(52) U.S. Cl. 428/611

(57) ABSTRACT

Laminated, composite, permanent magnets comprising layers of permanent magnets separated by layers of dielectric or high electrical resistivity substances, wherein the laminated magnets indicate increased electrical resistivity.

### BACKGROUND OF THE INVENTION

The present invention relates to rare earth composite, permanent magnets with reduced eddy current losses, suitable for use including in rotating machines, such as motors and generators. Addressing eddy current losses is critical in the design of motors and high speed generators. Reduction of these eddy current losses in permanent magnets used with rotating machines is preferably accomplished by increasing the electrical resistivity of permanent magnets. For example, when permanent magnets are subjected to variable magnetic flux, and the electrical resistivity is low, excessive heat is generated due to eddy currents. This increased heat reduces the magnetic properties, as well as the efficiency of rotating machines. Layers of high resistivity material incorporated within the permanent magnet material, perpendicular to the plane of the eddy currents, generally leads to a substantial decrease of eddy current losses.

Rare earth, composite, permanent magnets with improved electrical resistivity are described in U.S. Patent Publication No. US2006/0292395 A1 and U.S. Pat. Nos. 5,935,722; 7,488,395 B2; 5,300,317; 5,679,473; and 5,763,085.

The U.S. Patent Publication No. 2006/0292395 A1 teaches about the fabrication of a rare earth magnet with high strength and high electrical resistance. The structure includes R—Fe—B-based rare earth magnet particles which are enclosed with a high strength and high electrical resistance composite layer consisting of a glass phase or R oxide particles dispersed in a glass phase, and R oxide particle based mixture layers (R=rare earth elements).

The U.S. Pat. No. 5,935,722 teaches about the fabrication of laminated composite structures of alternating metal powder layers, and layers formed of an inorganic bonding media consisting of ceramic, glass, and glass-ceramic layers which are sintered together. The ceramic, glass, and glass-ceramic layers serve as an electrical insulation material used to minimized eddy current losses, as well as an agent that bonds the metal powder layers into a dimensionally-stable body.

The U.S. Pat. No. 7,488,395 B2 teaches on the fabrication of a functionally graded rare earth permanent magnets having a reduced eddy current loss. The magnets are based on R—Fe—B (R=rare earth elements) and the method consists in immersing the sintered magnet body into a slurry of powders containing fluorine and at least one element E selected from alkaline earth metal elements and rare earth elements, mixed with ethanol. Subsequent heat treatment of the magnets covered with the respective slurry allows for the absorption and infiltration of fluorine and element E from the surface into the body of the magnet. Thus, the magnet body includes a surface layer having a higher electric resistance than the interior.

However, there is no teaching or suggestion in the prior art of “intermediate”, “transition”, and/or “diffusion/reaction” layers, combined with laminated layers of permanent magnet materials based on Sm—Co or Nd—Fe—B and dielectric materials based on Ca and/or rare earth fluorides and oxyfluorides, with all the layers consolidated simultaneously, as disclosed and claimed in the present invention.

There is a need in the industry for alternative approaches to higher electrical resistivity, rare earth, composite, permanent magnets disclosed in the prior art. For example, the formation of monolithic laminated structures consisting of alternating layers of rare earth based magnets and dielectric materials or mixtures of rare earth rich alloys and dielectric materials offer unexpected advantages in electrical resistivity, particularly where the layers partly interact at the interface.

### OBJECTS OF THE INVENTION

An object of the invention is to form laminated, composite structures with increased electrical resistivity consisting of alternating dielectric and permanent rare earth magnet layers in order to reduce eddy current losses in motors and generators.

Another object of the invention is to form laminated, composite structures with increased resistivity consisting of alternating layers of (1) mixtures of dielectric and rare earth rich alloy, and (2) layers of permanent rare earth magnet material, in order to reduce eddy current losses in motors and generators.

Yet another object of the invention is to form laminated composite structures with increased resistivity consisting of alternating layers of (1) dielectric material, (2) transition (intermediary) rare earth rich alloy, and (3) rare earth magnet material, in order to reduce eddy current losses in motors and generators.

### BRIEF DESCRIPTION OF THE DRAWINGS

The above and other objects, features and other advantages of the present invention will be better understood from the following detailed description taken in conjunction with the accompanying drawings, in which FIGS. 1 through 8 illustrate various features of the high resistivity, composite, permanent, laminated structures of the invention.

FIGS. 1(a) and 1(b) show the schematic morphology of a green compact of laminated, composite, permanent magnet structures formed by pressing into a mold successive alternating, dielectric and rare earth magnet layers, or alternatively, layers of mixtures of dielectric and rare earth rich alloys and layers of rare earth magnet material. Additional details on the types of alternating layers are illustrated in FIGS. 2 through 4.

FIG. 2 shows the schematic morphology of laminated, composite, rare earth permanent magnet structures consisting of layers of dielectric materials sandwiched between layers of permanent magnet materials. Diffusion/reaction interface layers are formed between rare earth magnet layers and the dielectric layer, due to the elemental diffusion between the magnet layer and the dielectric layer.

FIG. 3 shows the schematic morphology of laminated, composite, rare earth permanent magnet structures with high resistivity layers, consisting of a mixture of dielectric materials and rare earth rich alloys, sandwiched between rare earth magnet layers. The diffusion/reaction interface layers are formed due to the elemental diffusion between the rare earth magnet layers and the high electrical resistivity layer.

FIG. 4(a) shows the schematic morphology of laminated, composite, permanent rare earth magnet structures consisting of dielectric layers sandwiched between rare earth rich alloy transition layers, which are positioned between rare earth magnet layers. The diffusion/reaction interface layers are formed due to the elemental diffusion between the dielectric layer and the rare earth rich alloy transition layer, and between the rare earth rich alloy transition layer and rare earth magnet layers.

FIG. 4(b) is an expanded view of FIG. 4(a), which schematically shows, as an example, the elemental diffusion between the CaF2 (dielectric) layer and the Sm-rich alloy transition layer and between the Sm-rich alloy transition layer and Sm—Co magnet layers, during thermal processing.

FIG. 5 shows the scanning electron microscopic image of a laminated Sm(Co, Fe, Cu, Zr)_{z} magnet with CaF₂ dielectric layers (emphasized on one single dielectric layer).

FIG. 6 shows a photo of laminated Sm(Co, Fe, Cu, Zr)_{z} magnets with CaF₂ dielectric layers.

FIG. 7(a) presents an elemental line scan across the interface between a CaF₂ dielectric inclusion and Sm(Co, Fe, Cu, Zr)_{z} magnet material, by using an energy dispersive X-ray analyzer.

FIG. 7(b) establishes that elemental diffusion occurs at the interface between the CaF₂ dielectric inclusion and the Sm(Co, Fe, Cu, Zr)_{z} magnet material, which results in altering the local stoichiometry.

FIG. 8 shows the demagnetization curves of laminated magnets with increased electrical resistivity, comprising of Sm(Co, Fe, Cu, Zr)_{z} magnet layers and CaF₂ layers alternatively pressed during the green compact processing under different morphologies, with full (complete) layers, partial centered layers and partial layers positioned towards one end or surface (magnetic pole) of the magnet.

### SUMMARY OF THE INVENTION

The following terms are defined as set out below, to insure a clear understanding of the invention and claims:

“Rare earth permanent magnets” are defined as permanent magnets based on intermetallic compounds with rare earth elements, RE, such as Nd and Sm, transition metals, such as Fe and Co, and, optional, metalloids such as B. Other elements may be added to improve magnetic properties.

“Laminated structures” are defined as structures containing layers of the same or different materials.

“Composite magnets” are defined as magnets consisting of at least two crystallographic phases with different compositions.

“Eddy current” is defined as the vortex currents generated in electrically conductive materials when exposed to variable magnetic fields.

“Electrical resistivity” is defined as a measure of how strongly a material opposes the flow of electric current.

“Dielectric” is defined as a material with high electrical resistivity exceeding 1 MΩ.

“High resistivity layer” is defined here as a layer of materials with electrical resistivity greater than that of the conventional rare earth permanent magnets.

“Rare earth rich alloy” is defined as an alloy containing one (or multiple) rare earth element(s) in an amount exceeding specific phase stoichiometries.

“Green compact” defines a specimen consolidated by pressing the precursor powders at room temperature, and having a density less than that of the bulk (with no porosity) counterpart.

“Elemental diffusion” is defined as the diffusion, migration or movement of the atomic species due to thermal activation.

“Diffusion/reaction interface layer” is here defined as the region between two materials where the original stoichiometry is altered due to the diffusion of the atomic species and their eventual interaction/reaction.

“Transition layer” is here defined as a layer of a material introduced on purpose in the laminated magnet structures to compensate as much as possible for the alteration of the stoichiometry at the interface between two layers with different compositions and functions (e.g., dielectric and magnet layers) due to elemental diffusion.

An accepted approach to minimizing eddy current losses in high performance rare earth permanent magnets used in electric motors or other rotating machines is to machine the rare earth permanent magnet into segments which are then assembled into the desired configuration or to alternatively blending the magnet powder precursor with an electrically insulating material. The present invention provides for an improved alternative approach comprising forming a monolithic laminated structure consisting of (1) alternating layers of rare earth based magnets and dielectric materials or (2) alternating layers of rare earth based magnets and layers of mixtures of rare earth rich alloys and dielectric materials.

The laminated, composite, permanent magnets of the present invention comprise alternating layers whose compositions partly interact at the interface. These composite, laminated, permanent magnets of the invention, as detailed in Examples 1 through 3 and further illustrated in Examples 4 through 11, show increases in electric resistivity over permanent magnets without dielectric additions. For example, increases of 170%, 244% to infinite electrical resistivity, respectively, are reported for Examples 1 through 3. Infinite electrical resistivity reported for Example 3 suggests total electrical insulation. In a preferred embodiment of the invention, dielectric substances are selected from the group consisting of calcium fluorides, oxides, oxyfluorides, rare earth fluorides, oxides, oxyfluorides and combinations thereof. See Table 2.

The preferred rare earth permanent magnet materials of the present invention include Sm—Co and Nd—Fe—B based intermetallic compounds, which are disclosed in Table 2.

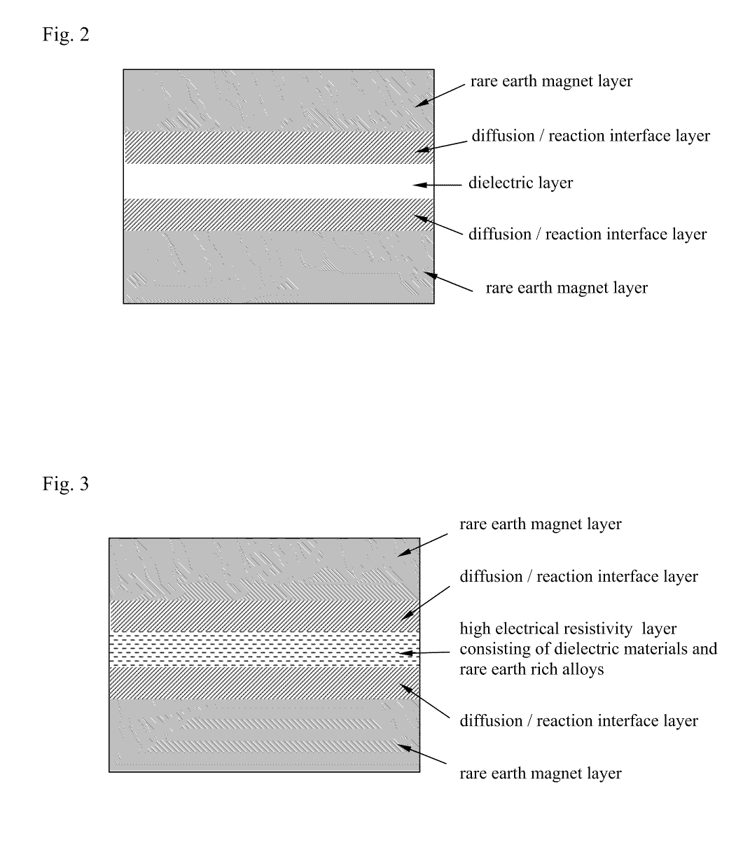

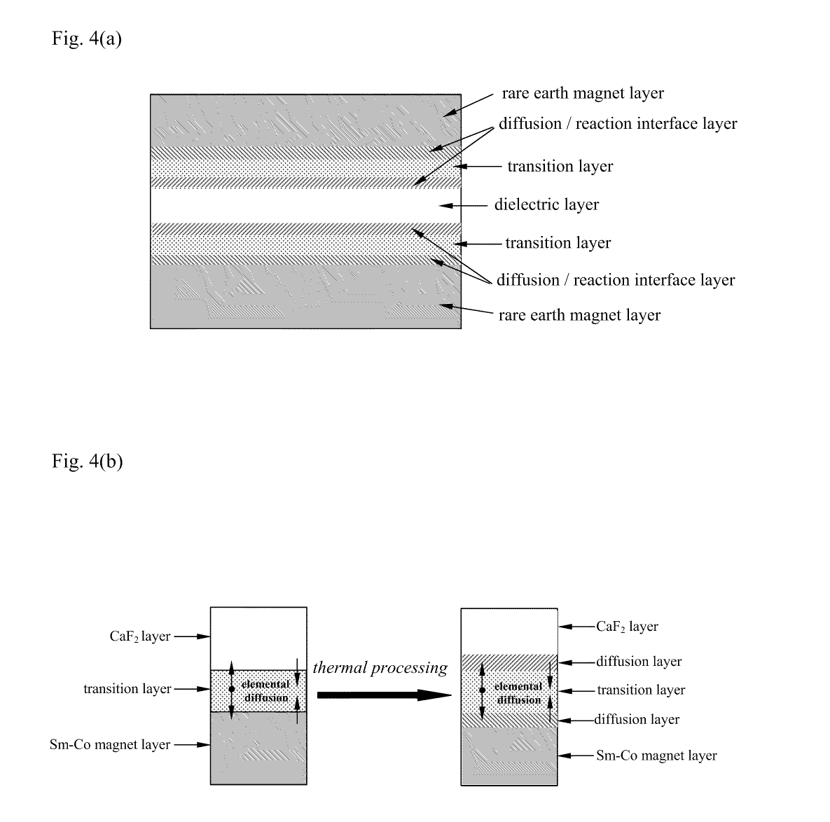

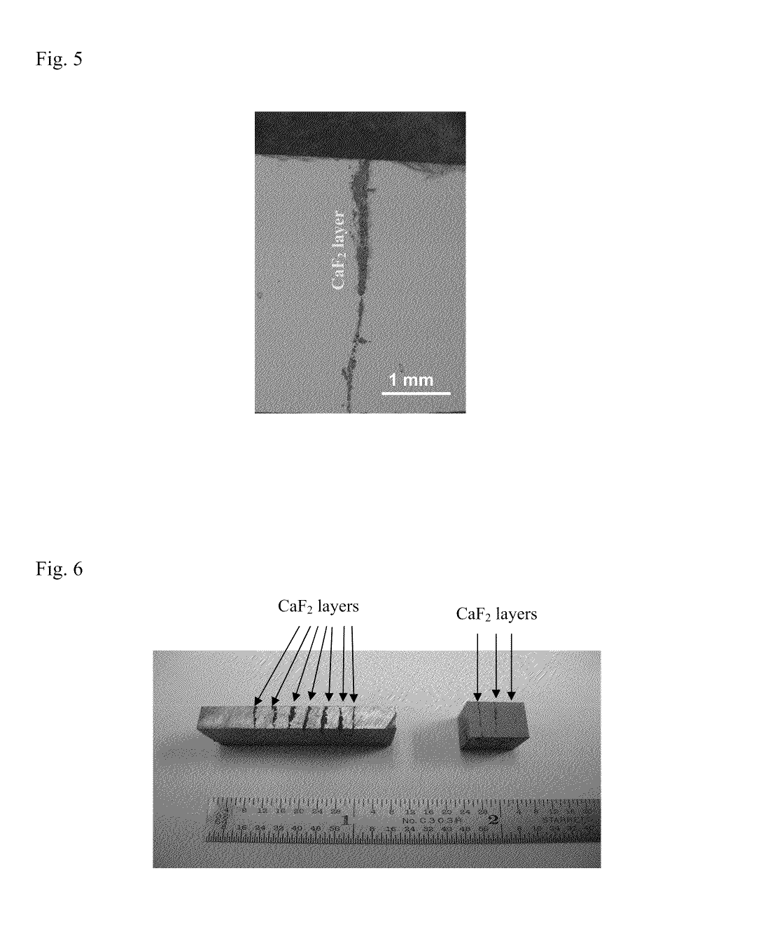

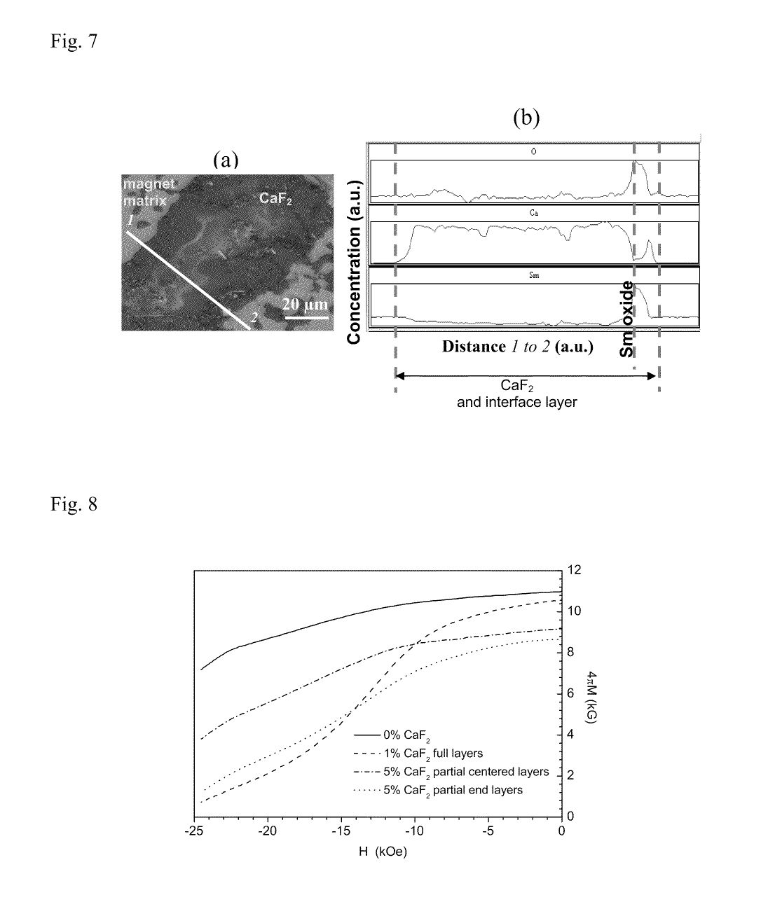

The distinctive magnetic properties of the present invention are obtained with a morphology consisting of alternating dielectric layers and rare earth permanent magnet layers as schematically illustrated in FIG. 2 of the Drawings. In the composite, laminated, permanent rare earth magnets of the invention, the dielectric substances partly interact with the magnet material, and locally modify the stoichiometry at the interface. In the present invention, the composition of the rare earth permanent magnet material, especially the amount of the rare earth component in the laminate, must be increased at the interface with the respective dielectric laminate layer. The requisite compensation can be achieved through different morphologies (a) by replacing pure dielectric substances with mixtures of dielectric substances with rare earth rich alloys as illustrated in FIG. 3 or (b) by using rare earth rich alloy transition layers between the dielectric and the magnet layers as illustrated in FIG. 4. The elemental diffusion associated with thermal processing of the laminate rare earth magnets of the invention is schematically illustrated in FIG. 4(b), where diffusion layers form at the interface between the Sm-rich layer and the dielectric layer, as well as between the Sm-rich layer and the Sm—Co magnet layer. The thickness of the dielectric or high electrical resistivity layer in the laminate is preferably adjusted between an upper limit determined by bonding strength and a lower limit controlled by layer continuity. In a preferred embodiment of the invention, the thickness of the dielectric or high electrical resistivity layer is normally less than 500 μm. More preferably, the dielectric layer or high electrical resistivity layer is less than 100 μm thick. The number of dielectric or high electrical resistivity layers in the laminate magnets will be determined by the applications. For high speed machines, more dielectric layers are preferred. The thickness of the magnet layer is determined by the application, and is usually not less that 500 μm.

The consolidation methods to achieve full density include sintering, hot pressing, die upsetting, spark plasma sintering, microwave sintering, infrared sintering, combustion driven compaction and combinations thereof.

The delamination of the so formed magnets can be controlled by the thickness of the dielectric or higher resistivity layer and its physical integrity, which is related to the bonding strength between and within the layers. The breakage of the laminated structures during the processing is controlled in the present invention with different morphologies of the green compact with (1) partial layers near one of the magnetic poles of the magnet and (2) partial layers in the center of the magnet.

Thus, one embodiment of the invention is a laminated, rare earth, composite, permanent magnet, having improved electrical resistivity, comprising alternate layers of rare earth permanent magnet material and dielectric material indicating high electrical resistivity, wherein said laminated structure also includes layers selected from the group consisting of diffusion reaction interface layers, transition layers and combinations thereof.

Another embodiment of the invention is a laminated, rare earth, composite, permanent magnet having improved electrical resistivity, comprising alternate layers of rare earth permanent magnet material and dielectric material indicating high electrical resistivity, wherein said rare earth permanent magnet material is selected from the group of intermetallic compounds consisting of:
RE(Co, Fe, Cu, Zr)_{z},
RE-TM-B,
RE₂™₁₄B,
RE-Co
RE₂Co₁₇,
RECo₅ and
combinations thereof;
   wherein z=6 to 9; RE is selected from the group consisting of rare earth elements including yttrium and mixtures thereof, and TM is selected from a group of transition metals consisting but not limited to Fe, Co and other transition metal elements, and said laminated, composite, rare earth permanent magnet structure includes layers selected from the group consisting of diffusion reaction interface layers, transition layers and combinations thereof.

Yet another embodiment of the invention is a laminated, composite, rare earth permanent magnet, having improved electrical resistivity comprising alternate layers of rare earth permanent magnet material and dielectric material indicating high electrical resistivity; wherein said dielectric material is selected from the group consisting of:
fluorides,
oxyfluorides,
CaFₓ
Ca(F,O)ₓ,
(RE,Ca)Fₓ,
(RE,Ca)(F,O)ₓ,
REF_{X},
RE(F,O)_{X}, and
mixtures thereof;
   wherein x=1 to 6; RE is selected from the group consisting of rare earth elements and mixtures thereof, and said laminated structure includes layers selected from the group consisting of diffusion reaction interface layers, transition layers and combinations thereof.

Another embodiment of the invention is a laminated, composite, rare earth permanent magnet as described herein, wherein the thickness of said dielectric layer is less than about 2 mm and more preferably less than 500 μM.

Yet another embodiment of the invention is a laminated, composite, rare earth permanent magnet as described herein, wherein said rare earth permanent magnet material layer is represented by the chemical formula

RE₁₁₊ₓTM_{88.3-x-y}B_{y}

where x=0 to 5, y=5 to 7; RE is selected from the group consisting of rare earth elements including Nd, Pr, Dy and Tb; and TM is selected from the group consisting of transition metal elements including Fe, Co, Cu, Ga and Al.

Another embodiment of the invention is a laminated, composite, rare earth magnet as described herein, wherein said transition layer consists of rare earth rich alloys represented by the formula

RE_{11.7+x}TM_{88.3-x-y}B_{y}

where x is between 5 and 80, y is between 0 and 6; RE is selected from the group consisting of rare earth elements including Nd, Pr, Dy and Tb; and TM is selected from the group consisting of transition metal elements including Fe, Co, Cu, Ga and Al.

Yet another embodiment of the invention is a laminated, composite, rare earth permanent magnet, as described herein, wherein said rare earth, permanent magnet material is represented by the formula

RE(CoᵤFeᵥCu_{w}Zrₕ)

wherein u is between about 0.5 and 0.8, v is between about 0.1 and 0.35, w is between about 0.01 and 0.2, h is between about 0.01 and 0.05, and z is between about 6 and 9; and wherein RE is selected from the group consisting of Sm, Gd, Er, Tb, Pr, Dy and combinations thereof.

Another embodiment of the invention is a laminated, rare earth, composite, permanent magnet, as described herein, wherein said rare earth magnet material is represented by the formula

RECoₓ

where x=4 to 6 and RE represents rare earth elements including Sm, Gd, Er, Tb, Pr, and Dy and mixtures thereof, while other metallic or non-metallic elements are optional and should not exceed 10 atomic %.

Yet another embodiment of the invention is a laminated, composite, rare earth permanent magnet as described herein, wherein said transition layer is a rare earth rich alloy having the formula

RE(CoᵤFeᵥCu_{w}Zrₕ)_{z}

wherein u=0 to 0.8, v=0 to 0.35, w=0 to 0.20, h=0 to 0.05, z=1 to 7; and RE is selected from the group consisting of rare earth elements and mixtures thereof.

Another embodiment of the invention is a laminated, composite, rare earth permanent magnet as described herein, wherein said transition layer is a rare earth rich alloy having the formula

RECoₓ

where x is from between 1 and 4 and RE is selected from the group consisting of rare earth elements and mixtures thereof.

Yet another embodiment of the invention is a laminated, composite, rare earth permanent magnet as described herein, wherein said high resistivity layer is selected from the group consisting of fluorides, oxyfluorides and oxides selected from the group consisting of CaFₓ, Ca(F,O)ₓ, (RE,Ca)Fₓ, (RE,Ca)(F,O)ₓ, REFₓ, RE(F,O)_{X} where x=1 to 6; and mixtures thereof; wherein said high resistivity layer comprises at least 30 weight % of said fluorides, oxyfluorides and oxides and the balance is a rare earth rich alloy having the formula

RE_{11.7+x}TM_{88.3-x-y}B_{y}

where x=5 to 80, y=0 to 6: RE is selected from the group consisting of rare earth elements selected from the group consisting of Nd, Pr, Dy, and Tb; and TM is selected from the group consisting of transition metal elements Fe, Co, Cu, Ga, and Al.

Another embodiment of the invention is a laminated, composite, rare earth permanent magnet as described herein, wherein said high resistivity layer is selected from the group consisting of fluorides, oxyfluorides and oxides selected from the group consisting of CaFₓ, Ca(F,O)ₓ, (RE,Ca)Fₓ, (RE,Ca)(F,O)ₓ, REFₓ, RE(F,O)ₓ and mixtures thereof where x=1 to 6; and wherein said high resistivity layer comprises at least 30 weight % of said fluorides, oxyfluorides and oxides and the balance is a rare earth rich alloy having the formula

RE(CoᵤFeᵥCu_{w}Zrₕ)_{z}

wherein u=0 to 0.8, v=0 to 0.35, w=0 to 0.20, h=0 to 0.05, z=1 to 7; and RE is selected from the group consisting of rare earth elements selected from the group consisting of Nd, Pr, Dy, and Tb.

Yet another embodiment of the invention is a laminated, composite, rare earth permanent magnet as described herein, wherein said high resistivity layer is selected from the group consisting of fluorides, oxyfluorides and oxides selected from the group consisting of CaFₓ, Ca(F,O)ₓ, (RE,Ca)Fₓ, (RE,Ca)(F,O)ₓ, REFₓ, RE(F,O)ₓ and mixtures thereof where x=1 to 6; and wherein said high resistivity layer comprises at least 30 weight % of said fluorides, oxyfluorides and oxides and the balance is a rare earth rich alloy having the formula

RECoₓ

wherein x=1 to 4.

Another embodiment of the invention is directed to improvements in electric motors and generators using high performance rare earth magnets, with the improvement comprising reducing eddy current losses with the use of laminated, rare earth, composite, permanent magnets having improved electrical resistivity as described herein.

Yet another embodiment of the invention is directed to improvements in rotating machines by improved eddy current losses through the use of high performance, composite, rare earth permanent magnets as described herein.

Another embodiment of the invention is a laminated, rare earth, composite, permanent magnet as described herein, wherein the diffusion reaction interface layer and transition layers are arranged according to FIGS. 4(a) and 4(b), wherein said layers may be discontinuous, non-planar and have irregular thickness.

Yet another embodiment of the invention is a laminated, rare earth, composite, permanent magnet as described herein, wherein said laminated layers are arranged as shown in FIG. 2, wherein said layers may be discontinuous, non-planar and have irregular thickness.

Another embodiment of the invention is a laminated, rare earth, composite, permanent magnet, as described herein, wherein said laminated layers are arranged as shown in FIG. 3, wherein said layers may be discontinuous, non-planar and have irregular thickness.

Yet another embodiment of the invention is a laminated, rare earth, composite, permanent magnet, as described herein, wherein said laminated layers are arranged as shown in FIG. 4(a), wherein said layers may be discontinuous, non-planar and have irregular thickness.

### DETAILED DESCRIPTION OF THE INVENTION

In the present invention, the laminated high electrical resistivity, rare earth permanent magnets consist of layers of different chemical compositions, namely rare earth permanent magnet layers, dielectric layer or, alternatively, high electrical resistivity layers, with optional transition layers.

### The Rare Earth Permanent Magnet Layer

The rare earth permanent magnet layer is preferably comprised of rare earth permanent magnets, including RE—Fe—B and RE—Co-based permanent magnets, wherein RE is at least one rare earth element including Y (yttrium). Some rare earth permanent magnet compositions suitable for use in the present invention are described in Table 2.

In a preferred embodiment, the rare earth magnet layer is represented by RE-Fe(M)-B comprised of 10-40 weight % of RE and 0.5-5 weight % of B (boron) with the balance of Fe. Nd, Pr, Dy and Tb are preferred elements for the RE, with Nd particularly preferred. Further, it is preferred to use Dy up to 50 weight %, preferably up to 30 weight % of the total amount of RE. In an effort to improve the coercive force, M represents other optional metallic elements, such as Nb, Al, Ga and Cu. The addition of Co improves the corrosion resistance and thermal stability, and may be added up to 25 weight % based on the total amount of the RE-Fe—B-based magnet, as a substitution for Fe. An additional amount exceeding 25 weight % unfavorably reduces the residual magnetic flux density and intrinsic coercive force. Nb is effective for preventing the overgrowth of crystals and enhancing thermal stability. Since an excess amount of Nb reduces the residual magnetic flux density, Nb is preferred to be added at up to 5 weight % based on the total amount of the RE-Fe—B-based magnet.

As stated above and detailed in Table 2, the rare earth magnet layer can also be RE₂Co₁₇-based magnets with 10-35 weight % of RE, 30 weight % or less of Fe, 1-10 weight % of Cu, 0.1-5 weight % of Zr, an optional small amount of other metallic elements such as Ti and Hf, with the balance comprising Co. The RE-Co-based, permanent rare earth magnet is preferred to have a cellular microstructure consisting of cells with 2:17 rhombohedral type crystallographic structure and cell boundaries with 1:5 hexagonal crystallographic structure. In this magnet, the rare earth element is preferably Sm, along with optional other rare earth elements such as Ce, Er, Tb, Dy, Pr and Gd. When the amount of RE is lower than 10 weight %, the coercive force is low, and the residual magnetic flux density is reduced when RE exceeds 39 weight %. Although a high residual induction, Br, can be achieved by the addition of Fe, a sufficient coercive force can not be obtained when the amount exceeds 30 weight %. It is preferable to add Fe at least 5 weight % in order to improve Br. Copper, Cu, contributes to improving the coercive force. However, the addition of less than 1 weight % shows no improving effect, and the residual magnetic flux density and coercive force are reduced when the addition exceeds 10 weight %.

As shown in Table 2, the rare earth permanent magnet layer in the laminate can also be RECo₅-based magnet with 25-45 weight % of RE, and the balance of Co. RE is preferably Sm and optional other rare earth elements.

Other metallic or non-metallic elements can be present in Nd—Fe—B and Sm—Co based laminated magnets at preferably less than 10 weight %. It is understood that the RE-Fe—B-based magnets and RE-Co-based magnets used in the present invention may include inevitable impurities such as C, N, O, Al, Si, Mn, Cr and combinations thereof.

### The Dielectric Layer

The dielectric layer consists of substances selected from the group consisting of fluorides, oxyfluorides, Ca(F,O)ₓ; (RE,Ca)Fₓ; (RE,Ca)(F,O)ₓ; REFₓ, RE(F,O)ₓ and mixtures thereof; wherein RE is selected from the group consisting of rare earth elements and mixtures thereof. See also Table 2.

### The High Electrical Resistivity Layer

The high electrical resistivity layer are mixtures of dielectric materials selected from the group consisting of fluorides, oxyfluorides, Ca(F,O)ₓ; (RE,Ca)Fₓ; (RE,Ca)(F,O)ₓ; REF_{X}, RE(F,O)_{X} and mixtures thereof; wherein RE is selected from the group consisting of rare earth elements and mixtures thereof, and rare earth rich alloys. These rare earth rich alloys are different for different types of magnet layers. The following are some examples of the rare earth rich alloys suitable for the high resistivity layer mixtures:
(1) In the case of RE-Fe(M)-B magnets, the rare earth rich alloy is RE_{11.7+x}TM_{88.3-x-y}B_{y}, where x=5 to 80, y=0 to 6, RE is selected from the group consisting of rare earth elements such as Nd, Pr, Dy, and Tb, and TM is selected from the group consisting of transition metal elements, Fe, Co, Cu, Ga, and A.
(2) In the case of RE(CoᵤFeᵥCu_{w}Zrₕ)_{z} magnets, the rare earth rich alloy is RE(CoᵤFeᵥCu_{w}Zrₕ)_{z} (u=0 to 0.8, v=0 to 0.35, w=0 to 0.10, h=0 to 0.05, z=1 to 7).
(3) In the case of RECoₓ magnets, the rare earth rich alloy is RECoₓ (x=4-6), where RE is preferably Sm with optional other rare earth elements such as Gd, Er, Tb, Pr, and Dy, and other metallic or non-metallic elements are optional and should not be over 10 weight %.

### The Transition Layer

The transition layer inserted on purpose to compensate for the diffusion or reaction between the dielectric and permanent magnet layers is different for different types of magnet layers. The following are some examples of the rare earth rich alloys suitable for the transition layers:
(1) In the case of RE-Fe(M)-B magnets, the rare earth rich alloy is RE_{11.7+x}TM_{88.3-s-y}B_{y}, where x=5 to 80, y=0 to 6, RE is selected from the group consisting of rare earth elements such as Nd, Pr, Dy, and Tb, and TM is selected from the group consisting of transition metal elements, Fe, Co, Cu, Ga, and A.
(2) In the case of RE(CoᵤFeᵥCu_{w}Zrₕ)_{z} magnets, the rare earth rich alloy is RE(CoᵤFeᵥCu_{w}Zrₕ)_{z} (u=0 to 0.8, v=0 to 0.35, w=0 to 0.10, h=0 to 0.05, z=1 to 7).
(3) In the case of RECoₓ magnets, the rare earth rich alloy is RECoₓ (x=4-6), where RE is preferably Sm with optional other rare earth elements such as Gd, Er, Tb, Pr, and Dy, and other metallic or non-metallic elements are optional and should not be over 10 weight %.

### Processing Methods

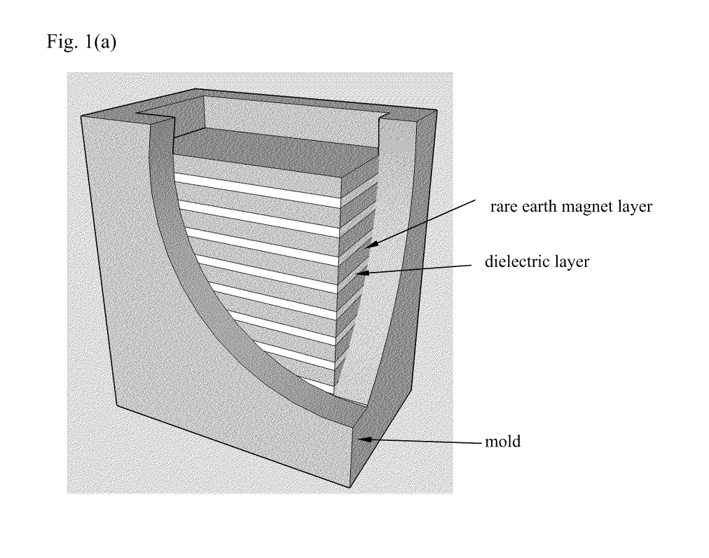

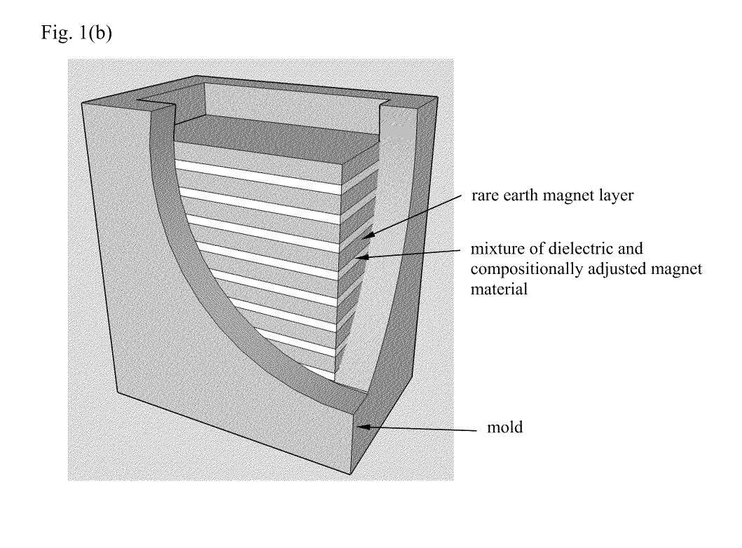

The laminated rare earth permanent magnets of the invention with high electrical resistivity can be produced by pressing the alternating layers as illustrated in FIGS. 1(a) and 1(b), accompanied by thermal processing to reach full density. The layers of the laminated permanent magnet should be preferably perpendicular to the plane of the eddy currents and parallel with the direction of the magnetization of the magnet. This thermal processing can include sintering, hot pressing, die upsetting, spark plasma sintering, microwave sintering, infrared sintering, combustion driven compaction and combinations thereof. See also Table 2.

The magnet powder may be prepared by coarsely pulverizing the precursor ingots produced by melting and casting the starting material and pulverizing in a jet mil, ball mil, etc., to particles having an average size of 1-10 μm, preferably 3-6 μm. The dielectric material can be in form of powders, flakes or very thin sheets. The green compact of the laminated magnets is formed by pressing the layers (both magnetic and non-magnetic) under a pressure of 500-3000 kgf/cm² in a magnetic field of 1-40 kOe. The green compact is then consolidated, for example, by sintering at 1000°-1250° C. for 1-4 hours in vacuum or in an inert gas atmosphere such as Ar atmosphere. The sintered product may be further homogenized and heat-treated to develop the hard magnetic properties.

### EXAMPLES

Table 1 summarizes Examples 1 through 3 and describes the magnetic properties and electrical resistivity enhancement of fully dense laminated Sm(Co, Fe, Cu, Zr)_{z} permanent magnets, where increases in electrical resistivity over standard permanent magnets of 170%, 244% and infinity are reported.

TABLE 1
shows the magnetic properties and electrical resistivity enhancement
of some of fully dense laminated Sm(Co,Fe,Cu,Zr)_{z} permanent magnets.

| | | | Magnetic Properties | | |
|---|---|---|---|---|---|
| | | Electrical | Residual | Intrinsic | Maximum Energy |
| | | Resistivity | Induction, | Coercivity, | Product, |
| Example | Morphology# | Increase* (%) | Bᵣ (kG) | H_{ci} (kOe) | (BH)ₘₐₓ (MGOe) |
| Example 1 | 1 wt % CaF₂, 10 | 170% | 10.6 | >25 | 25.1 |
| | full layer | | | | |
| Example 2 | 5 wt % CaF₂, 10 | 244% | 8.7 | >25 | 17.5 |
| | non-complete | | | | |
| | layers | | | | |
| Example 3 | 5 wt % CaF₂, 8 | ∞ | 9.1 | >25 | 19.7 |
| | non-complete | | | | |
| | layers | | | | |

#Details on these examples are set out below.
*Tested from parts machined out of the layered region of the laminated permanent magnets

### Example 1

Anisotropic Sm(Co, Fe, Cu, Zr)_{z}/CaF₂ laminated magnets with increased electrical resistivity were synthesized by regular powder metallurgical processes consisting of sintering at 1195° C., solution treatment at 1180° C. and aging at 850° C. followed by a slow cooling to 400° C. The total weight of each magnet was approximately 110 grams. The total amount of CaF₂ addition in the laminated magnet was 1 weight % and there were 10 layers of CaF₂. The following are the magnetic properties and electrical resistivity data:

Residual induction, Bᵣ: 10.6 kG
Intrinsic coercivity, H_{ci}:>25 kOe
Maximum energy product, (BH)ₘₐₓ: 25.1 MGOe
Electrical resistivity increased by 170% as compared to magnets without dielectric additions.

### Example 2

Anisotropic Sm(Co, Fe, Cu, Zr)_{z}/CaF₂ laminated magnets with increased electrical resistivity were synthesized by regular powder metallurgical processes consisting of sintering at 1195° C., solution treatment at 1180° C. and aging at 850° C. followed by a slow cooling to 400° C. The total weight of each magnet was approximately 110 grams. The total amount of CaF₂ addition was 5 weight %. There were 10 layers of CaF₂ distributed within approximately a quarter of the volume of the part, towards an end which was a magnetic pole. The following are the magnetic properties and electrical resistivity data:

Residual induction, Bᵣ: 8.7 kG
Intrinsic coercivity, H_{ci}:>25 kOe
Maximum energy product, (BH)ₘ: 17.5 MGOe
Electrical resistivity of the layered region increased by 244% as compared to magnets without dielectric additions.

### Example 3

Anisotropic Sm(Co, Fe, Cu, Zr)_{z}/CaF₂ laminated magnets with increased electrical resistivity were synthesized by regular powder metallurgical processes consisting of sintering at 1195° C., solution treatment at 1180° C. and aging at 850° C. followed by a slow cooling to 400° C. The total weight of each magnet was approximately 425 grams. About 300 grams of magnet powder was added in the mold as a shell supported by non magnetic steels shims, leaving an empty core. Alternating layers of magnet powder and CaF₂ were individually hand pressed into the cavity. The total amount of CaF₂ distributed in 8 layers within the core region was 5 weight %. The following are the magnetic properties and electrical resistivity data:

Residual induction, Bᵣ: 9.1 kG
Intrinsic coercivity, H_{ci}: >25 kOe
Maximum energy product, (BH)ₘₐₓ: 19.7 MGOe
Electrical resistivity was infinite, suggesting that at least one layer assured a total electrical insulation.

The present invention is further described by the illustrative examples set out in Table 2, which provides illustrative Examples 4 though 11 of typical morphologies of the laminated rare earth permanent magnets. The projected increase of the electrical resistivity of such laminated magnets is at least 100% compared to the electrical resistivity of conventional magnets. Manufacturing methods for the laminated composite rare earth magnets include sintering, hot pressing, die upsetting, spark plasma sintering, microwave sintering, infrared sintering and combustion driven compaction. In Table 2, x=1 to 6, if not otherwise specified.

The following notes apply to each of the following Examples as indicated therein by the appropriate symbol (#, +, and *) wherein:
# RE is preferably Sm with optional other rare earth elements such as Gd, Er, Tb, Pr, and Dy. Other metallic or non-metallic elements are optional and preferably less than about 10 wt %.
+ RE is selected from the group consisting of rare earth elements such as Nd, Pr, Dy, and Tb, and TM is selected from the group of transition metal elements such as Fe, Co, Cu, Ga, and Al. Other metallic or non-metallic elements are optional and preferably less than about 10 wt %.
* The diffusion layer contains the listed compounds and other phases, including rare earth transition metal alloys.

TABLE 2
EXAMPLE 4

| | | |
|---|---|---|
| Permanent magnet layer | Dielectric layer | Diffusion layer |

| | | | |
|---|---|---|---|
| Typical | Typical | Transition layer | Typical |

| | thickness | | thickness | | Typical | | thickness |
|---|---|---|---|---|---|---|---|
| Composition | in mm | Composition | in μm | composition | thickness | Composition* | in μm |
| RE(CoᵤFeᵥCu_{w}Zrₕ)_{z} | 0.5-10 | CaFₓ | <500 | | | (Sm,Ca)Fₓ | <100 |
| u = 0.5 to 0.8, | | Ca(F,O)ₓ | | | | (Sm,Ca)(F,O)ₓ | |
| v = 0.1 to 0.35, | | (RE,Ca)Fₓ | | | | (RE,Sm,Ca)Fₓ | |
| w = 0.01 to 0.20, | | (RE,Ca)(F,O)ₓ | | | | (RE,Sm,Ca)(F,O)ₓ | |
| h = 0.01 to 0.05, | | REFₓ | | | | (RE,Sm)Fₓ | |
| z = 6 to 9 | | RE(F,O)ₓ | | | | (RE,Sm)(F,O)ₓ | |
| # | | | | | | | |

EXAMPLE 5

| Permanent magnet layer | | High electrical resistivity layer | | | | | Diffusion layer | |
|---|---|---|---|---|---|---|---|---|
| | Typical | composition | | Typical | Transition layer | | | Typical |
| | thickness | mixtures of | | thickness | | Typical | | thickness |
| Composition | in mm | <70 wt % | >30 wt % | in μm | composition | thickness | composition* | in μm |
| RE(CoᵤFeᵥCu_{w}Zrₕ)_{z} | 0.5-10 | RE(CoᵤFeᵥCu_{w}Zrₕ)_{z} | CaFₓ | <500 | | | (Sm,Ca)Fₓ | <100 |
| u = 0.5 to 0.8, | | u = 0 to 0.8, | Ca(F,O)ₓ | | | | (Sm,Ca)(F,O)ₓ | |
| v = 0.1 to 0.35, | | v = 0 to 0.35, | (RE,Ca)Fₓ | | | | (RE,Sm,Ca)Fₓ | |
| w = 0.01 to 0.20, | | w = 0 to | (RE,Ca)(F, | | | | (RE,Sm,Ca)(F,O)ₓ | |
| h = 0.01 to 0.05, | | 0.10, | O)ₓ | | | | | |
| z = 6 to 9 | | h = 0 to 0.05, | REFₓ | | | | (RE,Sm)Fₓ | |
| # | | z = 1 to 7 | RE(F,O)ₓ | | | | (RE,Sm)(F,O)ₓ | |
| | | # | | | | | | |

EXAMPLE 6

| | | | | | | | | Diffusion layer 2 | |
|---|---|---|---|---|---|---|---|---|---|
| | | | | | | Diffusion layer 1 | | (between transition and | |
| | | | | | | (between dielectric and | | permanent magnet | |
| Permanent magnet layer | | Dielectric layer | | Transition layer | | transition layers) | | layers) | |
| | Typical | | Typical | | Typical | | Typical | | Typical |
| | thick- | | thick- | | thick- | | thick- | | thick- |
| | ness | | ness | | ness | | ness | | ness |
| Composition | in mm | composition | in μm | composition | in μm | composition* | in μm | composition | in μm |
| RE(CoᵤFeᵥCu_{w}Zrₕ)_{z} | 0.5-10 | CaFₓ | <500 | RE(CoᵤFeᵥCu_{w}Zrₕ)_{z} | <200 | (Sm,Ca)Fₓ | <100 | RE(CoᵤFeᵥCu_{w}Zrₕ)_{z} | <100 |
| u = 0.5 to 0.8, | | Ca(F,O)ₓ | | u = 0 to 0.8, | | (Sm,Ca)(F, | | u = 0 to 0.8, | |
| v = 0.1 to 0.35, | | | | v = 0 to 0.35, | | O)ₓ | | v = 0 to | |
| w = 0.01 to 0.20, | | (RE,Ca)Fₓ | | w = 0 to 0.10, | | (RE,Sm, | | 0.35, | |
| h = 0.01 to 0.05, | | | | h = 0 to 0.05, | | Ca)Fₓ | | w = 0 to | |
| z = 6 to 9 | | (RE,Ca)(F,O)ₓ | | z = 1 to 7 | | (RE,Sm,Ca)(F, | | 0.10, | |
| # | | | | # | | O)ₓ | | h = 0 to | |
| | | REFₓ | | | | (RE,Sm)Fₓ | | 0.05, | |
| | | RE(F,O)ₓ | | | | (RE,Sm)(F, | | z = 1 to 8.5 | |
| | | | | | | O)ₓ | | # | |

EXAMPLE 7

| | | |
|---|---|---|
| Permanent magnet layer | Dielectric layer | Diffusion layer |

| | | | |
|---|---|---|---|
| Typical | Typical | Transition layer | Typical |

| | thickness | | thickness | | Typical | | thickness |
|---|---|---|---|---|---|---|---|
| composition | in mm | composition | in μm | composition | thickness | composition* | In μm |
| RECoₓ | 0.5-10 | CaFₓ | <500 | | | (RE,Ca)Fₓ | <100 |
| x = 4-6 | | Ca(F,O)ₓ | | | | (RE,Ca)(F,O)ₓ | |
| # | | (RE,Ca)Fₓ | | | | (RE,Ca)Fₓ | |
| | | (RE,Ca)(F,O)ₓ | | | | (RE,Ca)(F,O)ₓ | |
| | | REFₓ | | | | REFₓ | |
| | | RE(F,O)ₓ | | | | RE(F,O)ₓ | |

EXAMPLE 8

| | | |
|---|---|---|
| Permanent magnet layer | High electrical resistivity layer | Diffusion layer |

| | | | | |
|---|---|---|---|---|
| Typical | composition | Typical | Transition layer | Typical |

| | | | | |
|---|---|---|---|---|
| thickness | mixtures of | thickness | Typical | thickness |

| composition | in mm | <70 wt % | >30 wt % | in μm | Composition | thickness | composition* | in μm |
|---|---|---|---|---|---|---|---|---|
| RECoₓ | 0.5-10 | RECoₓ | CaFₓ | <500 | | | (Sm,Ca)Fₓ | <100 |
| x = 4-6 | | x = 1-4 | Ca(F,O)ₓ | | | | (Sm,Ca)(F,O)ₓ | |
| # | | # | (RE,Ca)Fₓ | | | | (RE,Ca)Fₓ | |
| | | | (RE,Ca)(F, | | | | (RE,Ca)(F,O)ₓ | |
| | | | O)ₓ | | | | | |
| | | | REFₓ | | | | REFₓ | |
| | | | RE(F,O)ₓ | | | | RE(F,O)ₓ | |

EXAMPLE 9

| | | | | | | | | Diffusion layer 2 | |
|---|---|---|---|---|---|---|---|---|---|
| | | | | | | Diffusion layer 1 | | (between transition and | |
| | | | | | | (between dielectric and | | permanent magnet | |
| Permanent magnet layer | | Dielectric layer | | Transition layer | | transition layers) | | layers) | |
| | Typical | | Typical | | Typical | | Typical | | Typical |
| | thickness | | thickness | | thickness | | thickness | | thickness |
| composition | in mm | composition | in μm | composition | in μm | composition* | in μm | composition | in μm |
| RECoₓ | 0.5-10 | CaFₓ | <500 | RECoₓ | <200 | (RE,Ca)Fₓ | <100 | RECoₓ | <100 |
| x = 4-6 | | Ca(F,O)ₓ | | x = 1-4 | | (RE,Ca)(F,O)ₓ | | x = 1-6 | |
| # | | (RE,Ca)Fₓ | | # | | (RE,Ca)Fₓ | | # | |
| | | (RE,Ca)(F,O)ₓ | | | | (RE,Ca)(F,O)ₓ | | | |
| | | REFₓ | | | | REFₓ | | | |
| | | RE(F,O)ₓ | | | | RE(F,O)ₓ | | | |

EXAMPLE 10

| | | |
|---|---|---|
| Permanent magnet layer | Dielectric layer | Diffusion layer |

| | | | |
|---|---|---|---|
| Typical | Typical | Transition layer | Typical |

| | thickness | | thickness | | Typical | | thickness |
|---|---|---|---|---|---|---|---|
| composition | in mm | composition | in μm | composition | thickness | composition* | in μm |
| RE_{11.7+x}TM_{88.3-x-y}B_{y} | 0.5-10 | CaFₓ | <500 | | | (RE,Ca)Fₓ | <100 |
| x = 0 to 5, | | Ca(F,O)ₓ | | | | (RE,Ca)(F,O)ₓ | |
| y = 5 to 7 | | (RE,Ca)Fₓ | | | | (RE,Ca)Fₓ | |
| + | | (RE,Ca)(F,O)ₓ | | | | (RE,Ca)(F,O)ₓ | |
| | | REFₓ | | | | REFₓ | |
| | | RE(F,O)ₓ | | | | RE(F,O)ₓ | |

EXAMPLE 11

| Permanent magnet layer | | High electrical resistivity layer | | | | | Diffusion layer | |
|---|---|---|---|---|---|---|---|---|
| | Typical | Composition | | Typical | Transition layer | | | Typical |
| | thickness | mixtures of | | thickness | | Typical | | thickness |
| composition | in mm | <70 wt % | >30 wt % | in μm | composition | thickness | composition* | in μm |
| RE_{11.7+x}TM_{88.3-x-y}B_{y} | 0.5-10 | RE_{11.7+x}TM_{88.3-x-y}B_{y} | CaFₓ | <500 | | | (RE,Ca)Fₓ | <100 |
| x = 0 to 5, | | x = 5 to 80, | Ca(F,O)ₓ | | | | (RE,Ca)(F,O)ₓ | |
| y = 5 to 7 | | y = 0 to 6 | (RE,Ca)Fₓ | | | | (RE,Ca)Fₓ | |
| + | | | (RE,Ca)(F, | | | | (RE,Ca)(F,O)ₓ | |
| | | | O)ₓ | | | | | |
| | | | REFₓ | | | | REFₓ | |
| | | | RE(F,O)ₓ | | | | RE(F,O)ₓ | |

What is claimed is:

1. A laminated, rare earth, composite, permanent magnet, having improved electrical resistivity, comprising alternate layers of rare earth permanent magnet material and dielectric material indicating high electrical resistivity, wherein said laminated structure also includes layers selected from the group consisting of diffusion reaction interface layers, transition layers and combinations thereof.

2. A laminated, rare earth, composite, permanent magnet having improved electrical resistivity, comprising alternate layers of rare earth permanent magnet material and dielectric material indicating high electrical resistivity, wherein said rare earth permanent magnet material is selected from the group of intermetallic compounds consisting of:
RE(Co, Fe, Cu, Zr)_{z},
RE-TM-B,
RE₂TM₁₄-B,
RE-Co
RE₂Co₁₇,
RECo₅ and
combinations thereof;
wherein z=6 to 9; RE is selected from the group consisting of rare earth elements including yttrium and mixtures thereof, and TM is selected from a group of transition metals consisting but not limited to Fe, Co and other transition metal elements, and said laminated, composite, rare earth permanent magnet structure includes layers selected from the group consisting of diffusion reaction interface layers, transition layers and combinations thereof.

3. A laminated, composite, rare earth permanent magnet, having improved electrical resistivity comprising alternate layers of rare earth permanent magnet material and dielectric material indicating high electrical resistivity; wherein said dielectric material is selected from the group consisting of:
fluorides,
oxyfluorides,
CaFₓ
Ca(F,O)ₓ,
(RE,Ca)Fₓ,
(RE,Ca)(F,O)ₓ,
REFₓ,
RE(F,O)ₓ, and
mixtures thereof;
wherein x=1 to 6; RE is selected from the group consisting of rare earth elements and mixtures thereof, and said laminated structure includes layers selected from the group consisting of diffusion reaction interface layers, transition layers and combinations thereof.

4. A laminated, composite, rare earth permanent magnet according to claim 1, wherein the thickness of said dielectric layer is less than about 2 mm and more preferably less than 500 μm.

5. A laminated, composite, rare earth permanent magnet according to claim 1, wherein said rare earth permanent magnet material layer is represented by the chemical formula
RE_{11.7+x}TM_{88.3-x-y}B_{y}
where x=0 to 5, y=5 to 7; RE is selected from the group consisting of rare earth elements including Nd, Pr, Dy and Tb; and TM is selected from the group consisting of transition metal elements including Fe, Co, Cu, Ga and Al.

6. A laminated, composite, rare earth magnet according to claim 1, wherein said transition layer consists of rare earth rich alloys represented by the formula
RE_{11.7+x}TM_{88.3-x-y}B_{y}
where x is between 5 and 80, y is between 0 and 6; RE is selected from the group consisting of rare earth elements including Nd, Pr, Dy and Tb; and TM is selected from the group consisting of transition metal elements including Fe, Co, Cu, Ga and Al.

7. A laminated, composite, rare earth permanent magnet, according to claim 1, wherein said rare earth, permanent magnet material is represented by the formula
RE(CoᵤFeᵥCu_{w}Zrₕ)
wherein u is between about 0.5 and 0.8, v is between about 0.1 and 0.35, w is between about 0.01 and 0.2, h is between about 0.01 and 0.05, and z is between about 6 and 9;
and wherein RE is selected from the group consisting of Sm, Gd, Er, Tb, Pr, Dy and combinations thereof.

8. A laminated, rare earth, composite, permanent magnet, according to claim 1, wherein said rare earth magnet material is represented by the formula
RECoₓ
where x=4 to 6 and RE represents rare earth elements including Sm, Gd, Er, Tb, Pr, and Dy and mixtures thereof, while other metallic or non-metallic elements are optional and should not exceed 10 atomic %.

9. A laminated, composite, rare earth permanent magnet according to claim 1, wherein said transition layer is a rare earth rich alloy having the formula
RE(CoᵤFeᵥCu_{w}Zrₕ)_{z}
wherein u=0 to 0.8, v=0 to 0.35, w=0 to 0.20, h=0 to 0.05, z=1 to 7; and RE is selected from the group consisting of rare earth elements and mixtures thereof.

10. A laminated, composite, rare earth permanent magnet according to claim 1, wherein said transition layer is a rare earth rich alloy having the formula
RECoₓ
where x is from between 1 and 4 and RE is selected from the group consisting of rare earth elements and mixtures thereof.

11. A laminated, composite, rare earth permanent magnet according to claim 1, wherein said high resistivity layer is selected from the group consisting of fluorides, oxyfluorides and oxides selected from the group consisting of CaFₓ, Ca(F,O)ₓ, (RE,Ca)Fₓ, (RE,Ca)(F,O)ₓ, REFₓ, RE(F,O)ₓ where x=1 to 6; and mixtures thereof;
wherein said high resistivity layer comprises at least 30 weight % of said fluorides, oxyfluorides and oxides and the balance is a rare earth rich alloy having the formula
RE_{11.7+x}TM_{88-x-y}B_{y}
where x=5 to 80, y=0 to 6: RE is selected from the group consisting of rare earth elements selected from the group consisting of Nd, Pr, Dy, and Tb; and TM is selected from the group consisting of transition metal elements Fe, Co, Cu, Ga, and Al.

12. A laminated, composite, rare earth permanent magnet according to claim 1, wherein said high resistivity layer is selected from the group consisting of fluorides, oxyfluorides and oxides selected from the group consisting of CaFₓ, Ca(F,O)ₓ, (RE,Ca)Fₓ, (RE,Ca)(F,O)ₓ, REF_{X}, RE(F,O)_{X} and mixtures thereof where x=1 to 6; and
wherein said high resistivity layer comprises at least 30 weight % of said fluorides, oxyfluorides and oxides and the balance is a rare earth rich alloy having the formula
RE(CoᵤFeᵥCu_{w}Zrₕ)_{z}
wherein u=0 to 0.8, v=0 to 0.35, w=0 to 0.20, h=0 to 0.05, z=1 to 7; and RE is selected from the group consisting of rare earth elements selected from the group consisting of Nd, Pr, Dy, and Tb.

13. A laminated, composite, rare earth permanent magnet according to claim 1, wherein said high resistivity layer is selected from the group consisting of fluorides, oxyfluorides and oxides selected from the group consisting of CaFₓ, Ca(F,O)ₓ, (RE,Ca)Fₓ, (RE,Ca)(F,O)ₓ, REF_{X}, RE(F,O)_{X} and mixtures thereof where x=1 to 6; and
wherein said high resistivity layer comprises at least 30 weight % of said fluorides, oxyfluorides and oxides and the balance is a rare earth rich alloy having the formula
RECoₓ
wherein x=1 to 4.

14. In electric motors and generators using high performance rare earth magnets, the improvement comprising reducing eddy current losses with the use of laminated, rare earth, composite, permanent magnets having improved electrical resistivity of claim 1.

15. Rotating machines with improved eddy current losses comprising high performance, composite, rare earth permanent magnets of claim 1.

16. Laminated, rare earth, composite, permanent magnets according to claim 1, wherein the diffusion reaction interface layer and transition layers are arranged according to FIGS. 4(a) and 4(b), wherein said layers may be discontinuous, non-planar and have irregular thickness.

17. Laminated, rare earth, composite, permanent magnets according to claim 1, wherein said laminated layers are arranged as shown in FIG. 2, wherein said layers may be discontinuous, non-planar and have irregular thickness.

18. Laminated, rare earth, composite, permanent magnets, according to claim 1, wherein said laminated layers are arranged as shown in FIG. 3, wherein said layers may be discontinuous, non-planar and have irregular thickness.

19. Laminated, rare earth, composite, permanent magnets, according to claim 1, wherein said laminated layers are arranged as shown in FIG. 4(a), wherein said layers may be discontinuous, non-planar and have irregular thickness.
